(19) United States
(12) Patent Application Publication
(10) Pub. No.: US 2009/0279816 A1
(43) Pub. Date: Nov. 12, 2009

(54) FLUID DYNAMIC PRESSURE BEARING DEVICE, SPINDLE MOTOR AND DISK DRIVE APPARATUS INCLUDING SAME

(75) Inventors: Masato Gomyo, Kyoto (JP); Hironao Sasaki, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIDEC CORPORATION, Kyoto (JP)

(21) Appl. No.: 12/517,636

(22) PCT Filed: Dec. 5, 2007
(86) PCT No.: PCT/JP2007/073453

§ 371 Date: Jun. 4, 2009

(30) Foreign Application Priority Data
Dec. 5, 2006 (JP) 2006-327788

(51) Int. Cl. F16C 32/06; H02K 7/08; G11B 5/012

(52) U.S. Cl. 384/100; 310/90; G9B/5.024; 360/97.01

(57) ABSTRACT

In a fluid dynamic pressure bearing device using ionic liquid as lubricant, a shaft member and a sleeve member are not corroded by the ionic liquid and static electricity generated is not accumulated. Aluminum with an oxide film formed on its surface is used as the material of the shaft member 11 and the sleeve member 12 and aluminum exposure portions B1, B2 are provided on the surfaces making contact with the ionic liquid, other than dynamic pressure generating grooves, of the shaft member 11 and the sleeve member 12. Accordingly, the shaft member 11 and the sleeve member 12 are kept substantially in the same electric potential through the ionic liquid.

### BACKGROUND OF THE INVENTION

1. Field of Invention

The present invention relates to an fluid dynamic pressure bearing device and, more specifically, to a fluid dynamic pressure bearing device that makes use of an ionic liquid as its lubricant.

2. Description of the Related Art

Magnetic disk devices such as a hard disk drive (HDD) and the like are being greatly increased in capacity and reduced in size year by year. A spindle motor used therein is required to rotate at a high speed. For that reason, the spindle motor needs to have a lifespan long enough to endure the high speed rotation, quietness and superior rotational vibration accuracy. In view of this, a fluid dynamic pressure bearing in which one of a shaft member and a sleeve member rotates relative to the other with a gas or a liquid filled between them has been developed as a bearing structure for the spindle motor. In the fluid dynamic pressure bearing, the shaft member and the sleeve member are fitted so as to make rotation relative to each other. A radial bearing portion for supporting the radial load of the shaft member or the sleeve member and a thrust bearing portion for supporting the axial load of the shaft member or the sleeve member are formed in the shaft member and the sleeve member. In each of the radial and thrust bearing portions, the bearing surface of the sleeve member opposes the bearing surface of the shaft member with a minute gap left therebetween. Dynamic pressure generating grooves are formed on at least one of the bearing surfaces. In case of a liquid dynamic pressure bearing, the minute gap is filled with, e.g., a lubricant.

In the fluid dynamic pressure bearing, one of the shaft member and the sleeve member makes high speed rotation relative to the other in a non-contact state. Thus the rotating member is electrically charged as the lubricant flows within the bearing gap. In case the fluid dynamic pressure bearing is used in a disk drive apparatus, a disk is electrically charged by the friction with an air during its rotation. This causes static electricity to be accumulated in the rotating member. Conventionally, in an effort to drain the static electricity to a fixed member, a conductivity imparting agent such as conductive polymer, carbon black or the like is added to a lubricant mainly composed of ester oil, silicon oil, α-olefin oil or so forth.

Recently, attention is paid to the use, as a lubricant for a fluid dynamic pressure bearing, of an ionic liquid having an extremely low vapor pressure and higher conductivity than that of the conventionally available lubricant mainly composed of ester oil (see, e.g., Japanese Patent Laid-open Publication Nos. 2006-105207 and 2004-183868). If the ionic liquid is used as the lubricant, it becomes possible to drain the static electricity generated in the rotating member without having to add any conductivity imparting agent.

Since the ionic liquid is highly corrosive, however, it is often the case that it corrodes and rusts the stainless steel or other metal which has heretofore been used as a base material of the shaft member and the sleeve member of the fluid dynamic pressure bearing. The rusts thus generated may possibly shorten the lifespan of the fluid dynamic pressure bearing.

### SUMMARY OF THE INVENTION

In view of the problems described above, it is an object of the present invention to provide a fluid dynamic pressure bearing device that can prevent a shaft member and a sleeve member from being corroded by an ionic liquid even when the ionic liquid is used as a lubricant and can avoid accumulation of static electricity in the shaft member or the sleeve member.

Another object of the present invention is to provide a spindle motor stably rotatable for a long period of time with no accumulation of static electricity in a rotating unit and a disk drive apparatus provided with the spindle motor.

Based on the premise that an ionic liquid is used as a lubricant, the present inventors have selected and evaluated a number of highly anti-corrosive materials and have found that an aluminum body is free from corrosion even if it is not subjected to any surface treatment. However, use of the aluminum body as a base material of the fluid dynamic pressure bearing device poses problems in terms of wear resistance and seizure resistance. Taking this into account, an attempt was made to enhance wear resistance and strength by subjecting the aluminum body to anodization and forming an oxidized film on the surface thereof. However, formation of the oxidized film on the surface of the aluminum body reduces conductivity, which makes it impossible to drain the static electricity generated in a rotor unit. As a solution to this problem, aluminum exposure portions were provided on the surfaces of a stationary unit and a rotating unit, other than the dynamic pressure generating grooves, which make contact with an ionic liquid, so that electric charges can flow from the rotating unit to the stationary unit through the ionic liquid.

A fluid dynamic pressure bearing device in accordance with the present invention includes a stationary unit made of aluminum, a rotating unit made of aluminum and rotatably held by the stationary unit, a lubricant filled in a minute gap between the stationary unit and the rotating unit, and dynamic pressure generating grooves formed on a surface of at least one of the stationary unit and the rotating unit. The lubricant is an ionic liquid. Each of the stationary unit and the rotating unit includes a surface making contact with the lubricant and an oxidized film formed on at least the surface making contact with the lubricant. At least one of the stationary unit and the rotating unit includes a first aluminum exposure portion formed in a surface area thereof other than the dynamic pressure generating groove. The stationary unit and the rotating unit are kept substantially in the same electric potential through the ionic liquid.

The term “ionic liquid” used herein refers to organic acid salt having cations and anions and remaining in a melted and non-crystallized state over a broad temperature range of from −100° C. to 400° C.

With the fluid dynamic pressure bearing device of the present invention, aluminum with a film formed on its surface is used as the material of the stationary unit and the rotating unit. This makes it possible for the stationary unit and the rotating unit to have wear resistance and seizure resistance required in using them as bearing members, while exhibiting corrosion resistance against the ionic liquid. Furthermore, an ionic liquid having higher conductivity than that of the conventionally available lubricant mainly composed of ester oil is used as the lubricant, and aluminum exposure portions are provided on the surfaces of the stationary unit and the rotating unit which make contact with the ionic liquid. Therefore, the static electricity generated in the rotating unit flows to the stationary unit through the ionic liquid. This eliminates the need to take a static electricity preventing measure using the mechanical contact of an earth brush or the like.

In addition, if the ionic liquid has volume resistivity of 10⁷ Ω·cm or less at 25° C., it becomes possible to rapidly drain the electric charges generated in the rotating unit to the stationary unit.

With the spindle motor and the disk drive apparatus of the present invention, they are provided with the fluid dynamic pressure bearing device mentioned above. This makes it possible to secure stable rotation for a long period of time with no accumulation of static electricity in the rotating unit.

### BRIEF DESCRIPTION OF THE DRAWINGS

FIG. 1 is a section view showing one example of a fluid dynamic pressure bearing device in accordance with the present invention.

FIGS. 2A and 2B are explanatory views illustrating positions of exposure portions provided in the fluid dynamic pressure bearing device shown in FIG. 1.

FIG. 3 is a schematic configuration view showing a spindle motor in accordance with the present invention.

FIGS. 4A and 4B are views for explaining the flow of electric charges from a rotor hub to the fluid dynamic pressure bearing device.

FIG. 5 is a view for explaining the flow of electric charges from the fluid dynamic pressure bearing device to a bracket.

FIG. 6 is a schematic configuration view showing a disk drive apparatus in accordance with the present invention.

### EXPLANATION OF REFERENCE SYMBOLS

1 fluid dynamic pressure bearing device
11 shaft member (rotating unit)
12 sleeve member (stationary unit)
71 housing
72 spindle motor
73 disk (recording media)
77 access unit
B1,B2,B3,B4,B5 exposure portion

### DETAILED DESCRIPTION OF THE PREFERRED EMBODIMENTS

Hereinafter, a fluid dynamic pressure bearing device, a spindle motor and a disk drive apparatus in accordance with preferred embodiments of the present invention will be described in detail with reference to the accompanying drawings. It is to be understood, however, that the present invention shall not be limited to the preferred embodiments.

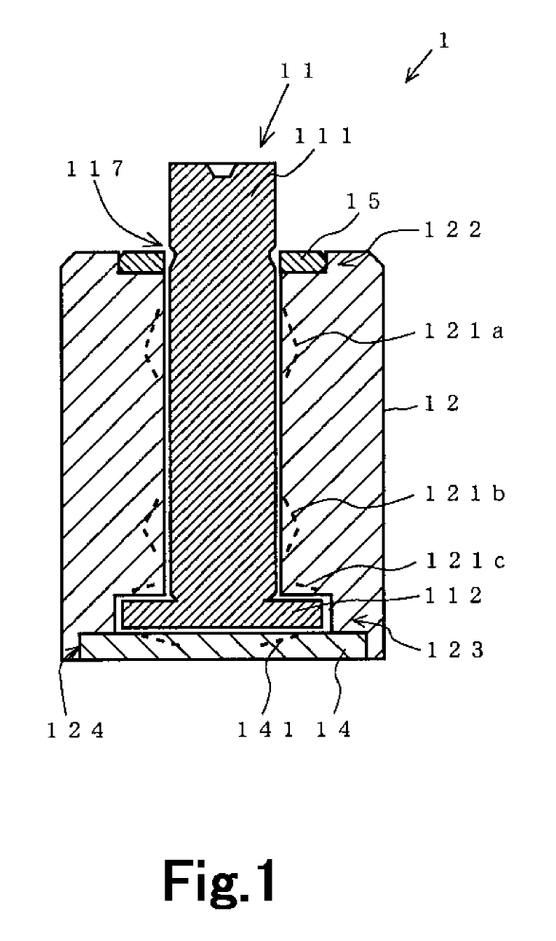

FIG. 1 is a section view showing a fluid dynamic pressure bearing device in accordance with a preferred embodiment of the present invention. The fluid dynamic pressure bearing device shown in FIG. 1 is what is called a full-fill type bearing device. The fluid dynamic pressure bearing device includes a sleeve member (or a stationary unit) 12 of hollow cylindrical shape having upper and lower openings. Groove portions 122 and 123 are provided in the upper end portion and the lower portion of the sleeve member 12, respectively. The groove portions 122 and 123 have an inner diameter greater than that of the remaining bore portion of the sleeve member 12. A fitting groove portion 124 having an inner diameter greater than that of the groove portion 123 is provided in the lower end portion of the sleeve member 12.

A shaft member (or a rotating unit) 11 includes a shaft portion 111 and a thrust plate portion 112 provided at the lower end of the shaft portion 111. The shaft portion 111 is inserted through the bore portion of the sleeve member 12 so that the thrust plate portion 112 of the shaft member 11 can be fitted in the groove portion 123 in a substantially concentric non-contact relationship with the latter. A thrust bush member 14 is fitted and secured to the fitting groove portion 124 of the sleeve member 12 in a substantially concentric non-contact relationship with the latter, thereby sealing the lower opening of the sleeve member 12.

A substantially annular seal member 15 is fitted around the shaft portion 111 and fixed to the upper opening of the sleeve member 12. The seal member 15 is mounted and fixed in the groove portion 122 so that the upper surface thereof can be flush with the upper end surface of the sleeve member 12. A lubricant (not shown) is filled in the minute gaps between the sleeve member 12, the thrust bush member 14 and the shaft member 11. The lubricant will be described later.

Two dynamic pressure generating groove arrays 121a and 121b are formed on the inner circumferential surface of the sleeve member 12 in an axially spaced-apart relationship with each other. The dynamic pressure generating groove arrays 121a and 121b and the lubricant which is filled in the minute gap between the sleeve member 12 and the shaft member 11 cooperate to form a pair of radial bearing portions that rotatably supports the shaft member 11 with respect to the sleeve member 12. Furthermore, a dynamic pressure generating groove array 121c is formed on the bottom surface of the groove portion 123 of the sleeve member 12 opposing the thrust plate portion 112 of the shaft member 11. In addition, a dynamic pressure generating groove array 141 is formed on the upper end surface of the thrust bush member 14 opposing the thrust plate portion 112 of the shaft member 11. The dynamic pressure generating groove arrays 121c and 141 and the lubricant filled in the minute gaps between the sleeve member 12, the thrust bush member 14 and the shaft member 11 cooperate to form thrust bearing portions that rotatably support the shaft member 11 with respect to the sleeve member 12 and the thrust bush member 14.

If the shaft member 11 rotates in the fluid dynamic pressure bearing device configured as above, the lubricant (not shown) held in the minute gaps between the sleeve member 12, thrust bush member 14 and the shaft member 11 is pressurized according to the groove patterns of the dynamic pressure generating groove arrays 121a, 121b, 121c and 141. Thus a number of partially high pressure portions are generated in the lubricant to support the radial load of the shaft member 11 in the radial bearing portions and to support the thrust load of the shaft member 11 in the thrust bearing portions.

In the fluid dynamic pressure bearing device of the present preferred embodiment, it is important to use aluminum as the material of the shaft member 11 and the sleeve member 12 and form films on the surfaces thereof. Use of the aluminum makes it possible to prevent the shaft member 11 and the sleeve member 12 from being corroded by the ionic liquid as the lubricant. Formation of the film makes it possible to enhance wear resistance and relative seizure resistance of the shaft member 11 and the sleeve member 12. In other words, the seizure resistance to the sleeve member 12 is enhanced if the aluminum is used as the material of the shaft member 11, whereas the seizure resistance to the shaft member 11 is enhanced if the aluminum is used as the material of the sleeve member 12. Conventionally available methods can be used in forming the film on the aluminum surface. Among others, it is preferable to form an oxidized film by anodizing the aluminum. At this time, an aqueous solution of oxalic acid, sulfuric acid or chromic acid can be used as an electrolyte. Since the surface of the aluminum body is porous immediately after electrolysis, it is preferable to subject the aluminum to a pore sealing treatment such as a boiling water treatment, a hot vapor treatment or the like.

In the fluid dynamic pressure bearing device of the present preferred embodiment, it is important to ensure that the oxidized film is not formed, and the base aluminum is exposed, in the portions of the shaft member 11 and the sleeve member 12 which make contact with the lubricant. This enables electric charges to move from the shaft member 11 to the sleeve member 12 through the lubricant, thereby preventing static electricity from being accumulated in the shaft member 11. The formation positions of the base aluminum exposure portions in the shaft member 11 and the sleeve member 12 are not particularly limited insofar as they are situated outside the dynamic pressure generating groove arrays but within the ionic liquid contact region.

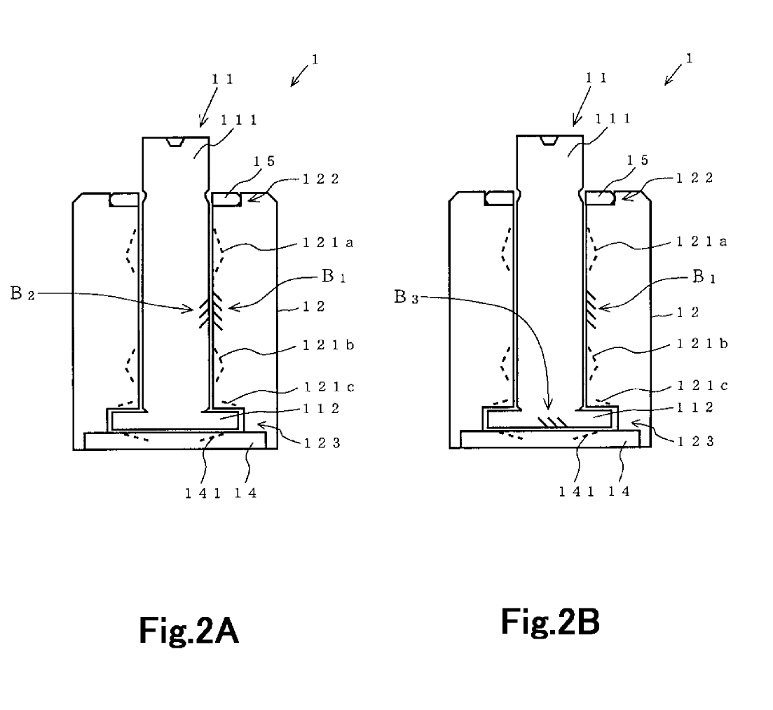

FIGS. 2A and 2B illustrate the formation positions and shape of the base aluminum exposure portions by way of example. In FIGS. 2A and 2B, the exposure portions are designated by B1, B2 and B3 and formed in the shape of stripes. In the fluid dynamic pressure bearing device shown in FIG. 2A, the exposure portion B1 of the sleeve member 12 is provided between the dynamic pressure generating groove arrays 121a and 121b and the exposure portion B2 of the shaft member 11 is provided in the opposing position with respect to the exposure portion B1. In the fluid dynamic pressure bearing device shown in FIG. 2B, the exposure portion B1 of the sleeve member 12 is provided between the dynamic pressure generating groove arrays 121a and 121b as in the example shown in FIG. 2A and the exposure portion B3 of the shaft member 11 is provided on the undersurface of the thrust plate portion 112. For the easy flow of electric charges, it is preferred that the exposure portions of the shaft member 11 and the sleeve member 12 are positioned adjacent to each other and have an increased area as far as possible. Although the exposure portions are formed in the shape of stripes in FIGS. 2A and 2B, they may be formed to have a planar shape. From the viewpoint of wear resistance and seizure resistance, however, it is preferred that the exposure portions are formed in the shape of stripes.

The exposure portions can be provided by, e.g., a method of forming an oxidized film on the surface of each of the shaft member 11 and the sleeve member 12 and then partially cutting away the oxidized film to expose the base aluminum or a method of masking a target exposure portion in a film formation process to prevent an oxidized film from being formed in the masked target exposure portion.

In the fluid dynamic pressure bearing device of the present preferred embodiment, it is also important to use an ionic liquid as the lubricant. In general, the ionic liquid has a low vapor pressure and seldom volatilizes, consequently performing a stable and superior bearing action for an extended period of time. The ionic liquid has low volume resistivity of about 10⁷ Ω·cm which is far lower than the volume resistivity, 10⁹ Ω·cm or more, of the conventional lubricant mainly composed of ester oil. This makes it easy for electric charges to move from the shaft member 11 to the sleeve member 12 through the ionic liquid. More preferably, the ionic liquid has volume resistivity of 1 Ω·cm or less at 25° C.

No particular limitation is imposed on the ionic liquid usable as the lubricant in the fluid dynamic pressure bearing device of the present preferred embodiment. Conventionally available ionic liquid can be used as the lubricant. One kind of ionic liquid or two or more kinds of ionic liquids may be used independently or in combination. Cations of the ionic liquid include, e.g., imidazolium, pyridinium, pyrazolium, piperidine, morpholine, piperazine, pyrrol, phosphonium and quaternary ammonium. Among them, it is preferable to use imidazolium. Preferably, imidazolium may be dialkyl imidazolium, alkyl-aryl imidazolium or diaryl imidazolium. Examples of dialkyl imidazolium include 1-methyl-3-propyl-imidazolium, 1-ethyl-3-methyl-imidazolium, 1-butyl-3-methyl-imidazolium and 1-hexyl-3-methyl-imidazolium. Examples of alkyl-aryl imidazolium include 1-aryl-3-methyl-imidazolium. Examples of diaryl imidazolium include 1,3-diaryl imidazolium. Among the six examples of imidazolium, it is more preferable to use 1-methyl-3-propyl-imidazolium or 1-ethyl-3-methyl-imidazolium.

Anions of the ionic liquid include, e.g., bis-(fluorosulfonic acid)-imide, bis-(trifluoromethylsulfonic acid)-imide, dicyandiamide, thiocyanic acid, trifluoromethanesulfonic acid and trifluoroacetic acid. Among them, it is particularly preferable to use bis-(fluorosulfonic acid)-imide.

If necessary, various kinds of additives well-known in the art, such as a viscosity index improver, a pour-point depressant, an antioxidant, a metal inert agent, an antirust agent and a corrosion inhibitor, may be blended with the ionic liquid.

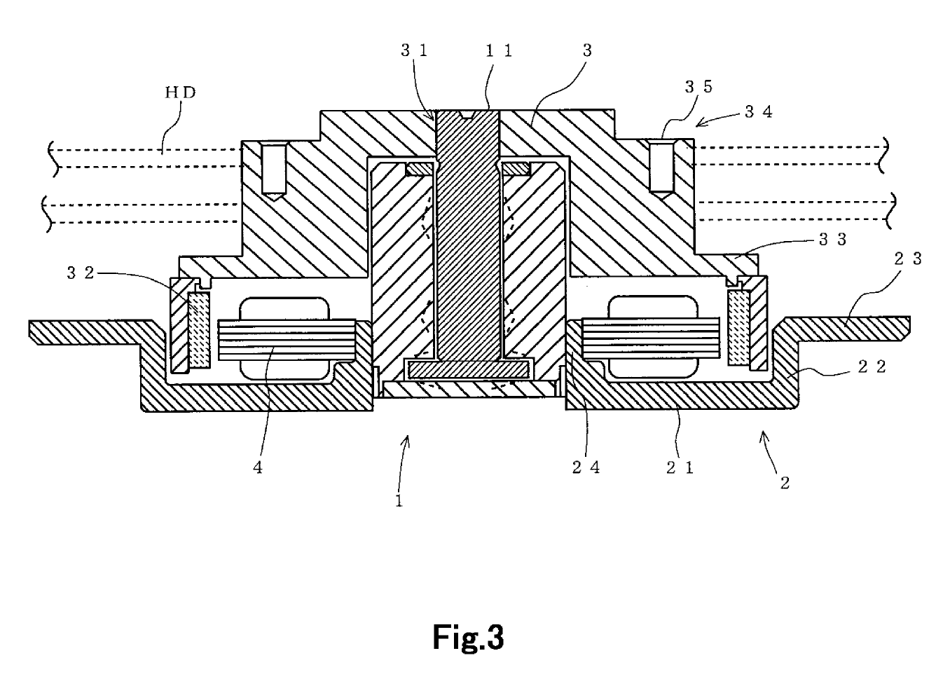

Next, description will be made on a spindle motor that makes use of the fluid dynamic pressure bearing device of the present preferred embodiment. FIG. 3 is a vertical section view showing a hard disk drive spindle motor provided with the full-fill type fluid dynamic pressure bearing device. A bracket (base) 2 preferably includes a base portion 21 provided to make contact with the outer circumferential surface of the sleeve member 12 in the circumferential direction, a peripheral wall 22 provided radially outwards of the base portion 21 and a rim portion 23 provided circumferentially outwards of the peripheral wall 22. The base portion 21, the peripheral wall 22 and the rim portion 23 are formed into a single piece so that they can be in a coaxial relationship with one another.

Provided radially inwards of the base portion 21 is an annular projection portion 24 to which is fitted and secured the fluid dynamic pressure bearing device shown in FIG. 1. The upper end of the shaft member 11 of the fluid dynamic pressure bearing device 1 is fitted and secured to a hole portion 31 provided in the upper central portion of a substantially cylindrical rotor hub 3. An annular multi-pole rotor magnet 32 magnetized with alternating poles in the circumferential direction is arranged to make contact with the inner circumferential surface of the rotor hub 3 over the full circumference of the latter. On the radial inner side of the rotor magnet 32, a stator 4 is arranged in the annular projection portion 24 of the base portion 21 in an opposing relationship with the rotor magnet 32. The stator 4 and the annular projection portion 24 may be fixed to each other by press-fit, bonding with an adhesive agent or the like.

A flange portion 33 is provided in the lower portion of the outer circumference of the rotor hub 3. One or more hard disks HD are mounted above the flange portion 33. More specifically, the hard disks HD are circumferentially position-determined by an outer peripheral portion 34 of the rotor hub 3. The hard disks HD are mounted above the flange portion 33 and then screw-fixed to hole portions 35 through a clamp member (not shown). Thus the hard disks HD are held against movement relative to the rotor hub 3.

In the spindle motor of this structure, the hard disks HD are electrically charged by the frictional contact with an air as they rotates at a high speed. The electric charges thus generated flow from the hard disks HD to the rotor hub 3, the shaft member 11, the lubricant, the sleeve member 12 and then the bracket 2. This reliably prevents the electric charges from being accumulated in the hard disks HD.

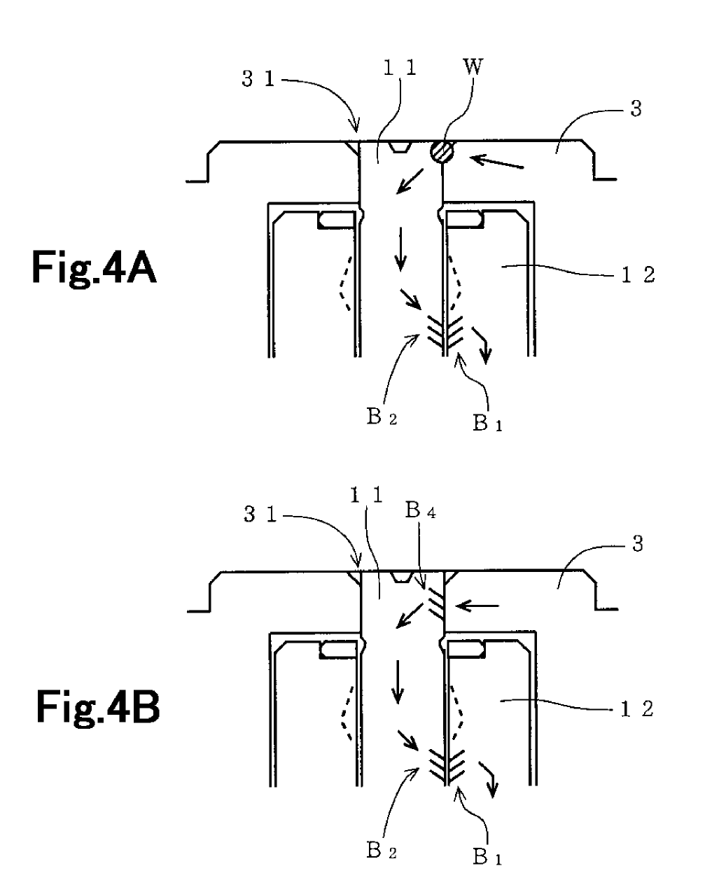

FIGS. 4A and 4B illustrate the flow of electric charges from the rotor hub 3 to the shaft member 11. In FIG. 4A, the upper end of the shaft member 11 fitted and secured to the hole portion 31 of the rotor hub 3. The contact area between the shaft member 11 and the rotor hub 3 is partially welded by laser welding or the like. This removes the oxidized film from the welded portion W, thereby rendering the rotor hub 3 and the shaft member 11 electrically conductive with each other. The electric conduction between the rotor hub 3 and the shaft member 11 makes it possible for the electric charges generated in the hard disks HD (see FIG. 3) to move from the hard disks HD through the rotor hub 3 and the welded portion W to the shaft member 11. As mentioned above, the electric charges moved to the shaft member 11 flow from the exposure portion B2 of the shaft member 11 to the sleeve member 12 via the lubricant (not shown) and the exposure portion B1. In FIG. 4B, the rotor hub 3 and the shaft member 11 are rendered electrically conductive with each other by forming an exposure portion B4, e.g., through cutting or other methods, in a portion of the shaft member 11 making contact with the rotor hub 3, instead of performing the partial welding in the portion W. In this case, the electric charges flow in the same manner as in FIG. 4B.

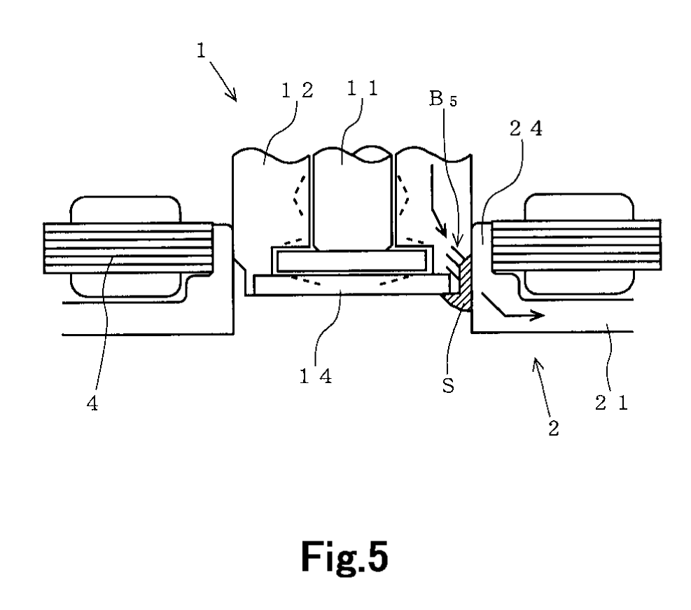

FIG. 5 illustrates the flow of electric charges from the sleeve member 12 to the bracket 2. In FIG. 5, the fluid dynamic pressure bearing device 1 is fitted and secured to the annular projection portion 24 of the bracket 2. An exposure portion B5 is provided, e.g., by cutting or other methods, in a portion of the sleeve member 12 making contact with the annular projection portion 24. A conductive adhesive agent S is applied so as to fill the gap between the exposure portion B5 and the bracket 2. In this way, the sleeve member 12 and the bracket 2 are rendered electrically conductive with each other. Thus the electric charges moved to the sleeve member 12 flow from the exposure portion B5 to the bracket 2 or flow from the exposure portion B5 to the bracket 2 through the conductive adhesive agent S. Alternatively, the bracket 2 and the sleeve member 12 may be fixed to each other by welding or other methods.

In the present preferred embodiment, stainless steel or other material is used as the material of the bracket 2 and the rotor hub 3 so that the electric charges can flow from the sleeve member 12 to the bracket 2 or from the rotor hub 3 to the shaft member 11. Needless to say, it may be possible to form the bracket 2 and the rotor hub 3 with aluminum. In case the bracket 2 and the rotor hub 3 are made of aluminum, they have substantially the same thermal expansion coefficient as that of the shaft member 11 and the sleeve member 12. This helps avoid occurrence of distortion or the like.

Next, description will be made on the disk drive apparatus in accordance with the present preferred embodiment. The disk drive apparatus includes an information access unit that performs at least one of information recording and reading tasks with respect to a disk-shaped storage medium mounted to the rotating unit of a spindle motor. The disk drive apparatus employs the spindle motor set forth above.

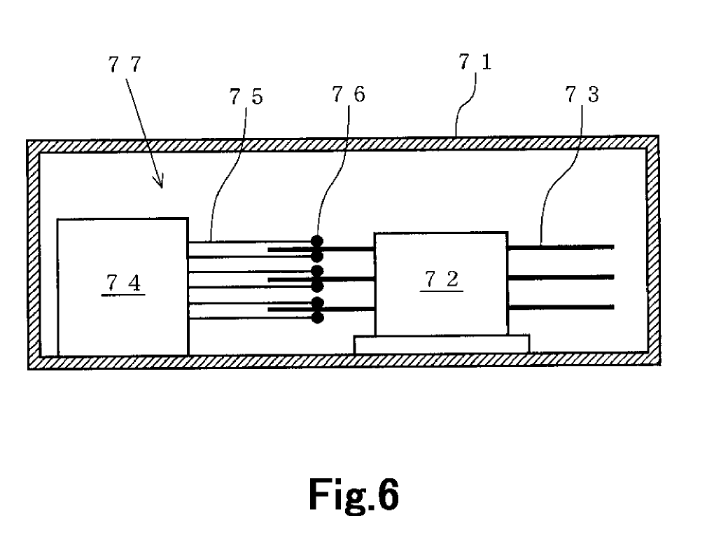

FIG. 6 schematically shows one example of the disk drive apparatus 70 in accordance with the present preferred embodiment. The disk drive apparatus 70 preferably includes a housing 71, a spindle motor 72 arranged within the housing 71 to rotatably support disk-shaped recording media 73 (hereinafter simply referred to as disks 73) that store various kinds of data in a digital format with increased density, and an access unit 77 arranged within the housing 71 to perform at least one of information recording and reading tasks with respect to the disks 73. The access unit 77 preferably includes heads 76 arranged to exchange data with the disks 73, arms 75 arranged to support the heads 76 and an actuator 74 arranged to move the heads 76 and the arms 75 to desired positions above the disks 73. The spindle motor described above is used as the spindle motor 72.

While certain preferred embodiments of the present invention have been described hereinabove, it will be apparent to those skilled in the art that many different changes and modifications may be made without departing from the scope and spirit of the invention.

For example, although the preferred embodiments described above is directed to the shaft-rotating motor in which the shaft member 11 is fixed to the rotor hub 3 with the sleeve member 12 fixed to the bracket (the stationary member), the present invention is not limited thereto but may equally apply to a shaft-fixed motor in which the shaft member 11 is fixed to the bracket 2 with the sleeve member 12 fixed to the rotor hub 3.

The film formed on the surface of the aluminum body is not limited to the anodized film but may be a nickel film or other plated films.

The scope of the present invention shall be defined by only the appended claims.

### INDUSTRIAL APPLICABILITY

As described above, an aluminum body having a surface coated with an oxidized film is used as the material of the stationary unit and the rotating unit in the fluid dynamic pressure bearing device, the spindle motor using the same and the disk drive apparatus in accordance with the preferred embodiments of the present invention. This makes it possible to obtain wear resistance and seizure resistance required in the bearing member while securing corrosion resistance against the ionic liquid. If the fluid dynamic pressure bearing device is used in, e.g., various kinds of motors as well as magnetic disk devices such as a hard disk drive (HDD) using a spindle motor and a high-capacity floppy disk drive (FDD), it becomes possible to increase the lifespan of the bearing thereof.

1. A fluid dynamic pressure bearing device, comprising:
a stationary unit made of aluminum;
a rotating unit made of aluminum and rotatably held by the stationary unit with a minute gap left between the stationary unit and the rotating unit;
an ionic liquid lubricant filled in the minute gap between the stationary unit and the rotating unit; and
dynamic pressure generating grooves formed on a surface of at least one of the stationary unit and the rotating unit,
wherein each of the stationary unit and the rotating unit includes a surface making contact with the lubricant and an oxidized film formed on at least the surface making contact with the lubricant,
at least one of the stationary unit and the rotating unit includes a first aluminum exposure portion provided in the surface thereof other than the dynamic pressure generating groove, and
the stationary unit and the rotating unit are kept substantially in the same electric potential through the ionic liquid lubricant.

2. The fluid dynamic pressure bearing device of claim 1, further comprising a rotor hub coupled to the rotating unit, wherein the rotating unit and the rotor hub are electrically connected to each other and kept substantially in the same electric potential.

3. The fluid dynamic pressure bearing device of claim 2, wherein the rotating unit includes a surface making contact with the rotor hub and a second aluminum exposure portion provided on the surface making contact with the rotor hub.

4. The fluid dynamic pressure bearing device of claim 2, wherein at least a portion of the rotor hub is welded to the rotating unit.

5. The fluid dynamic pressure bearing device of claim 2, wherein the rotating unit includes a surface making contact with the rotor hub and a second aluminum exposure portion provided on and/or around the surface making contact with the rotor hub, and a conductive material is interposed between the second aluminum exposure portion and the rotor hub.

6. The fluid dynamic pressure bearing device of claim 1, further comprising a base coupled to the stationary unit, wherein the stationary unit is electrically connected to the base and the stationary unit and the base are kept substantially in the same electric potential.

7. The fluid dynamic pressure bearing device of claim 6, wherein the stationary unit includes a surface making contact with the base and a third aluminum exposure portion provided on the surface making contact with the base.

8. The fluid dynamic pressure bearing device of claim 6, wherein at least a portion of the base is welded to the stationary unit.

9. The fluid dynamic pressure bearing device of claim 6, wherein the stationary unit includes a surface making contact with the base and a third aluminum exposure portion provided on and/or around the surface making contact with the base, and a conductive material is interposed between the third aluminum exposure portion and the base.

10. A fluid dynamic pressure bearing device, comprising:
a stationary unit made of aluminum;
a rotating unit made of aluminum and rotatably held by the stationary unit with a minute gap left between the stationary unit and the rotating unit;
a rotor hub coupled to the rotating unit;
an ionic liquid lubricant filled in the minute gap between the stationary unit and the rotating unit; and
dynamic pressure generating grooves formed on a surface of at least one of the stationary unit and the rotating unit,
wherein each of the stationary unit and the rotating unit includes a surface making contact with the lubricant and an oxidized film formed on at least the surface making contact with the lubricant,
the rotating unit includes a surface making contact with the rotor hub and a second aluminum exposure portion formed on and/or around the surface making contact with the rotor hub, and
the rotating unit and the rotor hub are electrically connected to each other through the second aluminum exposure portion and kept substantially in the same electric potential.

11. The fluid dynamic pressure bearing device of claim 10, further comprising a conductive material interposed between the second aluminum exposure portion and the rotor hub to electrically interconnect the rotating unit and the rotor hub and to keep the rotating unit and the rotor hub substantially in the same electric potential.

12. A fluid dynamic pressure bearing device, comprising:
a stationary unit made of aluminum;
a rotating unit made of aluminum and rotatably held by the stationary unit with a minute gap left between the stationary unit and the rotating unit;
a rotor hub coupled to the rotating unit;
an ionic liquid lubricant filled in the minute gap between the stationary unit and the rotating unit; and
dynamic pressure generating grooves formed on a surface of at least one of the stationary unit and the rotating unit,
wherein each of the stationary unit and the rotating unit includes a surface making contact with the lubricant and a film formed on at least the surface making contact with the lubricant, and
at least a portion of the rotor hub is welded to the rotating unit.

13. A fluid dynamic pressure bearing device, comprising:
a stationary unit made of aluminum;
a rotating unit made of aluminum and rotatably held by the stationary unit with a minute gap left between the stationary unit and the rotating unit;
a base coupled to the stationary unit;
an ionic liquid lubricant filled in the minute gap between the stationary unit and the rotating unit; and
dynamic pressure generating grooves formed on a surface of at least one of the stationary unit and the rotating unit,
wherein the stationary unit includes a surface making contact with the base and a third aluminum exposure portion provided on and/or around the surface making contact with the base, and
the stationary unit includes the surface making contact with the base and the third aluminum exposure portion provided on the surface making contact with the base,
the stationary unit and the base are electrically connected to each other through the third aluminum exposure portion and kept substantially in the same electric potential.

14. The fluid dynamic pressure bearing device of claim 13, further comprising a conductive material interposed between the third aluminum exposure portion and the base to electrically interconnect the rotating unit and the base and to keep the rotating unit and the base substantially in the same electric potential.

15. A fluid dynamic pressure bearing device, comprising:
a stationary unit made of aluminum;
a rotating unit made of aluminum and rotatably held by the stationary unit with a minute gap left between the stationary unit and the rotating unit;
a base coupled to the stationary unit;
an ionic liquid lubricant filled in the minute gap between the stationary unit and the rotating unit; and
dynamic pressure generating grooves formed on a surface of at least one of the stationary unit and the rotating unit,
wherein each of the stationary unit and the rotating unit includes a surface making contact with the lubricant and a film formed on at least the surface making contact with the lubricant, and
at least a portion of the base is welded to the stationary unit.

16. The fluid dynamic pressure bearing device of claim 1, wherein the ionic liquid has volume resistivity of 10⁷ Ω·cm or less at 25° C.

17. A spindle motor which comprises the fluid dynamic pressure bearing device of claim 1.

18. A disk drive apparatus for holding a disk-shaped storage medium capable of storing information, comprising:
a housing;
the spindle motor of claim 17 arranged within the housing to rotate the storage medium; and
an information access unit arranged to perform at least one of information recording and reading tasks with respect to the storage medium.
